(19) United States
(12) Patent Application Publication
(10) Pub. No.: US 2022/0366478 A1
(43) Pub. Date: Nov. 17, 2022

(54) AUTONOMOUS RECOMMENDATION SYSTEM BASED ON ANONYMOUS DATA

(71) Applicant: Intel Corporation, Santa Clara, CA (US)

(72) Inventors: Mario Jose DIVAN KOLLER, Hillsboro, OR (US); Marcos CARRANZA, Portland, OR (US); Cesar MARTINEZ_SPESSOT, Hillsboro, OR (US); Mateo GUZMAN, Beaverton, OR (US); Francesc GUIM BERNAT, Barcelona (ES)

(73) Assignee: Intel Corporation, Santa Clara, CA (US)

(21) Appl. No.: 17/876,596

(22) Filed: Jul. 29, 2022

(51) Int. Cl. G06Q 30/06; G06F 21/62

(52) U.S. Cl. CPC G06Q 30/0631; G06F 21/6254

(57) ABSTRACT

The application relates to an autonomous recommendation system, including: one or more BESs each configured to generate anonymous data representing customer-related information based on content streams from product-related cameras installed in a branch corresponding to the BES, and provide recommendation content to the branch based on the anonymous data; one or more ECSs each configured to aggregate the anonymous data from one or more BESs corresponding to respective branches in a region corresponding to the ECS to generate aggregated anonymous data shareable among regions corresponding to respective ECSs; and a DO configured to coordinate operations of the BESs and the ECSs based on predefined policies.

### TECHNICAL FIELD

Embodiments described herein generally relate to a recommendation system, and more particularly relate to an autonomous recommendation system based on anonymous data.

### BACKGROUND

A recommendation system may provide recommendations (e.g. advertisements, recommended products or services) to customers in a retail branch such as a bookstore, a grocery store or a supermarket. Present recommendation systems are usually not transparent enough about how to provide recommendations, and even these systems may use customer personal data to fit suggestions to a particular profile. Also, these systems may not adjust the content of the recommendations (e.g., excluding recommendation of alcoholic beverages) according to a specific profile (e.g., children).

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates an overall architecture diagram of an example autonomous recommendation system according to some embodiments of the present disclosure;

FIG. 2 illustrates a schematic diagram of an example data processing hierarchy for autonomous recommendation according to some embodiments of the present disclosure;

FIG. 3 illustrates an architecture diagram of an example autonomous recommendation system focusing on components related to generation of anonymous data representing customer-related information, according to some embodiments of the present disclosure;

FIG. 4 illustrates an architecture diagram of an example autonomous recommendation system focusing on components related to providing advertisement recommendations, according to some embodiments of the present disclosure;

FIG. 5 illustrates an architecture diagram of an example autonomous recommendation system focusing on components related to providing product or service recommendations, according to some embodiments of the present disclosure;

FIG. 6 illustrates an example flowchart of an autonomous recommendation procedure based on anonymous data according to some embodiments of the present disclosure;

FIG. 7 is a block diagram illustrating components, according to some example embodiments, able to read instructions from a machine-readable or computer-readable medium and perform any one or more of the methodologies discussed herein;

FIG. 8 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

In a retail branch such as a bookstore, a grocery store or a supermarket, a set of cameras may be installed to monitor behaviors of customers. A recommendation system may receive content streams (e.g. audio or video streams) from the cameras, detect predefined behavior patterns of interest (e.g. a youth's interaction with a particular product) from the received content streams, and provide valuable recommendations based on the detected behavior patterns of the customers.

It may be desirable for the recommendation system to comply with Artificial Intelligence (AI) Ethics values in Transparency, Privacy, Freedom and Autonomy. In other words, it may be desirable that the recommendation system may describe the behavior patterns while ensuring anonymized customer profiles, provide different levels of aggregation of customer profiles computed from anonymous data (e.g. associations between children and toys per branch or region, a customer's body language and its relationship with a kind of product, etc.), and provide transparent and autonomous recommendation sequences fitted to a target profile (e.g. Do not show scenes with alcoholic beverages to children). That is, a recommendation process carried out by the recommendation system should be transparent in obtaining anonymous data representing customer-related information and providing recommendation sequences based on the customer-related information.

According to some embodiments of the present disclosure, an autonomous recommendation system based on anonymous data representing customer-related information is proposed. The customer-related information may include objects (e.g. kinds of products, a youth woman, an older adult, etc.), events (e.g. promotions), interactions (e.g. product observing, body gestures) and entity profiles associated with one or more customers occurring in content streams captured by a set of cameras installed in a retail branch such as a bookstore, a grocery store or a supermarket. The autonomous recommendation system may detect and generalize occurrence of the customer-related information from the anonymous data based on a category of objects (e.g. a youth woman, dairy products, etc.), events, zones of the branch, interactions, and their associated frequencies, so the anonymous data may be in a form of frequency-based matrixes.

In addition, a data processing hierarchy for autonomous recommendation is proposed according to some embodiments of the present disclosure. The anonymous data representing customer-related information that is generated from a branch may be shared among multiple branches through the data processing hierarchy while preserving privacy, data ownership and transparency. Furthermore, the detection of anonymous data representing customer-related information may help to adapt the content of recommendations dynamically according to the target profile (e.g. youth).

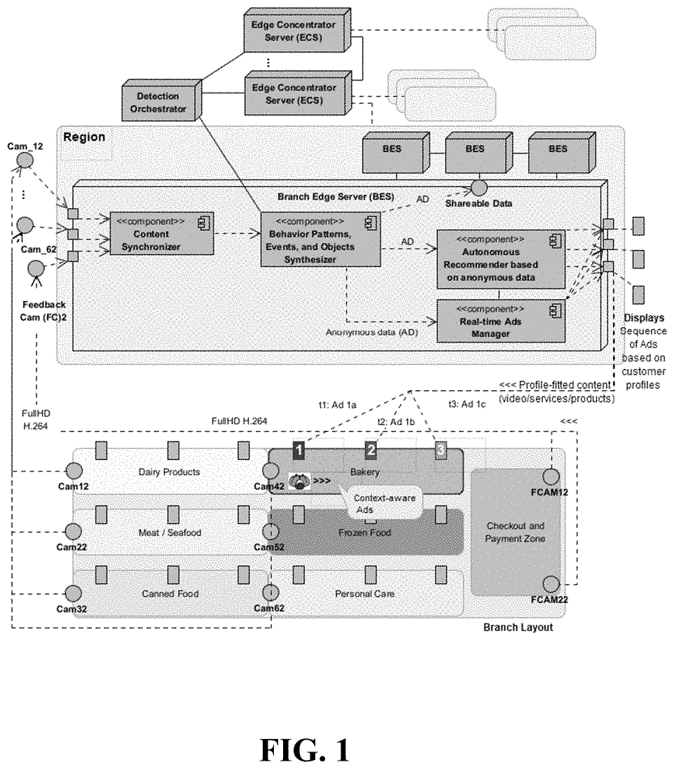

FIG. 1 illustrates an overall architecture diagram of an example autonomous recommendation system according to some embodiments of the present disclosure. For example, the autonomous recommendation system of FIG. 1 may be applied to a retail branch which wants to capitalize installed cameras and utilizes content streams captured by the cameras to selectively recommend advertisements, products, or services to a customer according to the customer's profile. Using the content streams (e.g. audio or video streams) from cameras, customer-related information including objects (e.g. kinds of products, a youth woman, an older adult, etc.), events (e.g. promotions), interactions (e.g., product observing, body gestures) may be detected to build anonymous frequency-based matrixes as anonymous data representing customer-related information. The anonymous data (i.e., frequency-based matrixes) may be used by a recommender to provide a sequence of suggested advertisements, products, or services per profile. Then videos related to offered advertisements, products, or services may be preprocessed to fit the offered advertisements, products, or services to the customer profile (e.g., cut part of videos unsuitable for children when the target profile is a kid). Finally, the processed videos may be provided to displays in the retail branch in order while fitting the resolution and encoding to the target displays.

In addition to the above mentioned cameras (herein referred to as “product-related cameras” (e.g. Cam_12 to Cam_62 in FIG. 1)) outputting the content streams for detection of customer-related information, a set of feedback-related cameras (e.g. FCAM11 and FCAM22 in FIG. 1) may be installed and used for identifying bought products so as to contrast the efficacy of the recommendations of the advertisements, products, or services.

As illustrated in FIG. 1, each branch may correspond to a Branch Edge Server (BES) configured to generate anonymous data representing customer-related information based on content streams from product-related cameras installed in the branch and provide recommendation content to the branch based on the anonymous data. Specifically, the BES may include a content synchronizer configured to collect and synchronize the content streams to generate the synchronized content streams based on a time reference; a customer-related information synthesizer (i.e. the behavior patterns, events, and objects synthesizer in FIG. 1) configured to detect occurrence of the customer-related information from the synchronized content streams to generate the anonymous data; and an autonomous recommender (including the autonomous recommender based on anonymous data and the real-time advertisement manager in FIG. 1) configured to produce the recommendation content based on the anonymous data. The recommendation content may include a sequence of advertisements, products, or services which may be adapted according to customer profiles or customer trajectories and presented to the customers on the displays installed in the branch.

According to some embodiments of the present disclosure, the anonymous data representing customer-related information may be shareable among multiple branches in a region or even among multiple branches in multiple regions. In the embodiments, the autonomous recommendation system may include one or more Edge Concentrator Servers (ECSs). Each ECS may correspond to a specific region including one or more branches and may be configured to aggregate the anonymous data from one or more BESs corresponding to respective branches in a region corresponding to the ECS to generate aggregated anonymous data shareable among regions corresponding to respective ECSs.

In addition, the autonomous recommendation system may further include a Detection Orchestrator (DO) configured to coordinate operations of the BESs and the ECSs based on predefined policies. The predefined policies may include temporal retention policies for the BESs and aggregation policies for the ECSs.

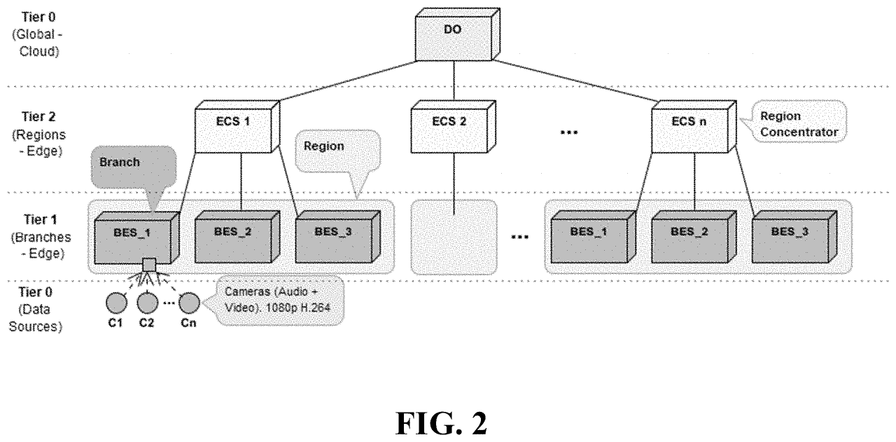

Thus the autonomous recommendation system may be implemented in accordance with a data processing hierarchy as shown in FIG. 2. In the data processing hierarchy, Tier 0 may include data sources from the installed cameras in the branches, Tier 1 may include one or more BESs corresponding to respective branches in one or more regions, Tier 2 may include one or more ECSs corresponding to respective regions, and Tier 3 may include a global-cloud DO for coordinating the operations of the BESs and the ECSs. For example, the DO may define and implement different tasks throughout the data processing hierarchy, such as a) Time synchronizer; b) Temporal Retention Policies; c) Aggregation Policies; d) Detection type specification (objects, events, and interactions); e) Visualization Strategy. The navigation between ECS and BES is bidirectional. In a direction from the BES to the ECS, a synthesis path may define how to deal with different levels of data aggregation, and in a direction from the ECS to the BES, a course of drilling down on anonymous data may be available. Anyway, the lowest level of the data processing hierarchy contains untraceable data, which may be limited to an anonymous profile, object, or event in a particular store.

It is noted that although the data processing hierarchy as shown in FIG. 2 is proposed according to some embodiments of the present disclosure, a BES for a specific branch may work with its own anonymous data to provide recommendations in case of disconnection with other ECSs or BESs in the data processing hierarchy. Of course, when a BES has connectivity to other ECSs and BESs, it is possible to share and use the anonymous data from different branches or regions as a compliment. This possibility is essential to consider in terms of data ownership and data regulations. However, a branch can work with the autonomous recommendation system even when other branches do not share their data (e.g., because they do not want to share due to data ownership or because they cannot share due to data regulations). Thus, the data processing hierarchy in FIG. 2 based on anonymous data may be created for the branches that want and can share their anonymous data.

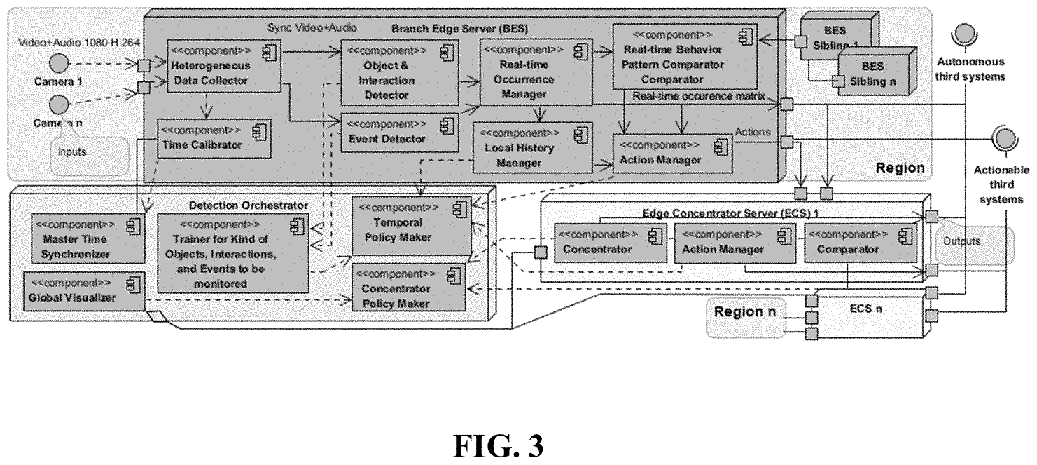

As described above, in order to provide autonomous recommendation based on anonymous data, how to generate the anonymous data and provide recommendation content based on the anonymous data may be critical issues to be addressed. These issues will be described in detail below with reference to FIG. 3 to FIG. 5.

FIG. 3 illustrates an architecture diagram of an example autonomous recommendation system focusing on components related to generation of anonymous data representing customer-related information, according to some embodiments of the present disclosure. As shown in FIG. 3, the heterogeneous data collector and the time calibrator may realize the functions of the content synchronizer in FIG. 1. Specifically, the heterogeneous data collector may collect and synchronize the content streams from the product-related cameras (e.g. Camera 1 to Camera n) based on a time reference to generate synchronized content streams. The time reference may be generated by the time calibrator based on a master timing signal from the DO which may be generated by a master time synchronizer in the DO, as illustrated in FIG. 3. It is noted here that the time reference may be generated in an alternative manner, for example, by an internal clock of the BES synchronized to a Network Time Protocol (NTP) server.

In FIG. 3, the object and interaction detector and the event detector may be configured to detect, from the synchronized content streams, occurrence of the customer-related information such as objects, interactions, events and entity profiles associated with one or more customers occurring in the synchronized content streams. Then the real-time occurrence manager (ROM) in FIG. 3 may be configured to generate frequency-based matrixes (i.e. real-time occurrence matrix in FIG. 3) from the detected occurrence of the customer-related information as the anonymous data. It can be easily understood that the behavior patterns, events, and objects synthesizer in FIG. 1 (i.e. the customer-related information synthesizer herein) may be instantiated by the object and interaction detector, the event detector and the real-time occurrence manager in FIG. 3.

Based on the proposed data processing hierarchy, the object and interaction detector and the event detector may be trained based on predefined objects, interactions and events in the DO, and the ROM may create and update frequency-based matrixes aligned with the predefined objects, interactions, and events in the DO. In this way, anonymous data representing customer-related information may be generated while preserving object/event/interaction typologies against the zones of the branch where an object, an event or an interaction occurs (e.g., a child observing toys in the target area).

Further, the anonymous data may be shared with a) other branches to compare behavior patterns (e.g. via the real-time behavior pattern comparator), b) external autonomous systems (e.g., autonomous third systems), and c) an action manager to trigger local or hierarchical actions (e.g., notify to a branch manager when a child is handling a wine bottle).

FIG. 3 also illustrates an example configuration of the DO and the ECS. For example, the DO may include a master time synchronizer for providing a master timing signal to the BES, a trainer for kinds of objects, interactions and events to be monitored, a temporal policy marker for providing temporal retention policies (e.g. action-related and data-retention policies) to the BES, a concentrator policy maker for providing aggregation policies (e.g. data aggregation policy per level) to the ECS, and a global visualizer for providing data visualization strategy. The ECS may collect actions and frequency-based matrixes (i.e., outputs of the lowest level of the data processing hierarchy) from a set of BESs. The ECS may aggregate the matrixes according to the data aggregation policy and transmit a new matrix to the next level (i.e., intermediary outputs). The next level may request a drill down from a synthesis as well (i.e., the inverse path implies a drill-down). Thus, the customer-related information such as objects, events or interactions associated with customers may be monitored and characterized for customer behavior tracking using the anonymous data shareable between regions.

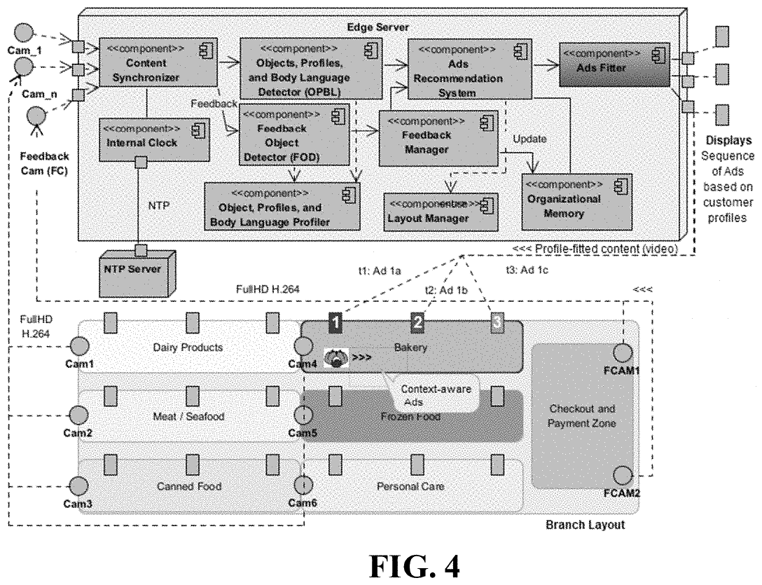

FIG. 4 illustrates an architecture diagram of an example autonomous recommendation system focusing on components related to providing advertisement recommendations, according to some embodiments of the present disclosure. As shown in FIG. 4, the components related to providing advertisement recommendations may include the advertisement recommendation system and the advertisement filter and may correspond to the real-time advertisement manager in FIG. 1. The advertisement recommendation system may be configured to provide a sequence of advertisements based on the anonymous data representing customer-related information, and the advertisement filter may be configured to adjust the advertisements based on a profile of a target customer.

In FIG. 4, the BES also includes the content synchronizer configured to collect and synchronize the content streams from the product-related cameras to generate synchronized content streams based on a time reference, and a customer-related information synthesizer (i.e. the objects, profiles, and body language detector (OPBL)) configured to detect occurrence of the customer-related information from the synchronized content streams to generate the anonymous data representing the customer-related information. It is noted that in the example autonomous recommendation system of FIG. 4, the time reference is generated by an internal clock of the BES synchronized to a NTP server, and the OPBL may correspond to the customer-related information synthesizer herein and the behavior patterns, events, and objects synthesizer in FIG. 1. The OPBL may be configured to detect kinds of products, profiles, and interactions (e.g., body language) and provide such anonymous data to the advertisement recommendation system.

In addition, the BES in the example autonomous recommendation system of FIG. 4 may further include a feedback object detector (FOD), a feedback manager, an organizational memory, a layout manager, and an object, profiles, and body language profiler. The FOD may be configured to detect information about bought products from feedback content streams from feedback-related cameras installed in the branch and feedback the information about the bought products to the advertisement recommendation system. The feedback manager may be configured to receive the information about the bought products and update the information about the bought products in the organization memory. The organizational memory may be configured to store the information about the bought products, and historical anonymous data and recommendation content generated based on previous experiences and knowledge. The layout manager may be configured to maintain a layout of the branch and positions of cameras and displays in the branch. The object, profiles, and body language profiler may be configured to define one or more kinds of objects, interactions, and events to be detected and may be referred to as an object-interaction-event profiler herein.

Specifically, with such a configuration of the BES, the set of cameras and displays in the retail branch may be mapped through the layout manager. Thus the cameras, the displays, and contexts of the branch may be identified within the branch, describing the outputs from the cameras (e.g., Full HD h.264 15 fps) and expected inputs in the displays (e.g., HD H.264). The internal clock may be synchronized to the NTP server for providing the time reference. The content synchronizer may receive the content streams from the product-related cameras and synchronizes them using the time reference. The output may be a set of synchronized content streams.

The synchronized content streams from the product-related cameras (e.g. the cameras Cam1 to Cam6) located in defined contexts may be sent to the objects, profiles, and body language detector (OPBL), and feedback content streams from feedback-related cameras (e.g. the cameras FCAM1, FCAM2 in the checkout and payment zone) may be sent to the FOD. The OPBL may detect kinds of products, profiles, and interactions (e.g., body language) and provide such anonymous data to the advertisement recommendation system. On the other hand, the FOD may detect bought products per time window, maintain the frequency of buys per product and inform the feedback manager. The feedback information may also be provided to the advertisement recommendation system to complement the anonymous data representing the customer-related information.

Furthermore, the feedback manager may update the information in the organizational memory used for training convolutional models and the recommendation system for fitting its behavior online. The advertisement recommendation system may use the information from the feedback manager and the OPBL to provide a sequence of advertisements (i.e., providing a transparent recommendation based on the anonymous data). The advertisements may be shown in a specific order following a customer's trajectory. An estimated trajectory may be computed by profile re-identification from the synchronized content streams. Thus, the advertisement fitter may analyze the content from suggested advertisements to cut or maintain frames based on the customer's profile accordingly (e.g., no scenes of alcoholic beverages drinking get shown to children). The fitted videos of advertisements may be sent to target displays in a suggested order.

The organizational memory may contain anonymous data of profiles and advertisements based on previous experiences and knowledge. The information in the organizational memory may be updated through the feedback manager. The organizational memory may be used at the start-up to initialize the advertisement recommendation system. Also, retail branches may share the information while keeping safe data privacy (i.e., the anonymous data of profiles may be shared).

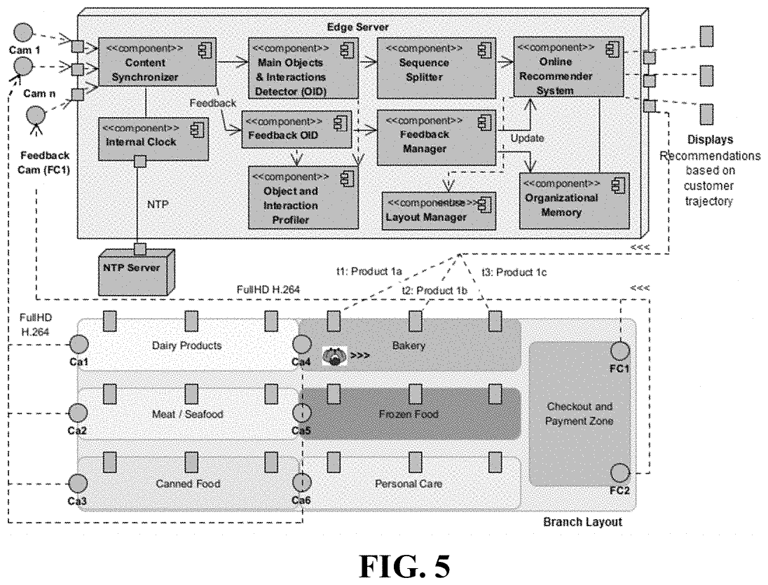

FIG. 5 illustrates an architecture diagram of an example autonomous recommendation system focusing on components related to providing product/service recommendations, according to some embodiments of the present disclosure. As shown in FIG. 5, the components related to providing product/service recommendations may correspond to the autonomous recommender component in FIG. 1 and include the sequence splitter and the online recommender system.

Similar to the illustration in FIG. 4, the BES in the example autonomous recommendation system of FIG. 5 may also include the content synchronizer, the main objects and interactions detector (OID) (corresponding to the OPBL in FIG. 4), the feedback OID (corresponding to the FOD in FIG. 4), the feedback manager, the organizational memory, the layout manager, and the object and interaction profiler (corresponding to the object, profiles, and body language profiler in FIG. 4 and the object-interaction-event profiler herein). Functions of these components may be similar to those illustrated and described above with reference to FIG. 4, so details about them will not be repeated here.

As shown in FIG. 5, there are two main regions in the retail branch: a product-related region and a feedback-related region. For example, the OID may receive customer-related video streams from the product-related cameras, and the feedback OID may receive feedback-related video streams from the feedback-related cameras. Thus, the feedback OID may detect the bought items in the cashier region and provide feedback to the organizational memory and the recommender system, so that the recommender system can contrast the recommended products to the effectively purchased products. On the other hand, the OID may receive the customer-related video streams from the product-related cameras and detect objects (e.g., kinds of products, a youth woman, an older adult, etc.), interactions (e.g., product observing), and movement patterns (e.g., body language) from the customer-related video streams.

The OID may send identifications of the elements (e.g., kinds of objects, interactions, and behavioral patterns) to the sequence splitter, which may maintain track of all the elements over time, respect the sequence and estimate a potential customer trajectory. The online recommender system may provide a sequence of recommendations of products and services associated with the customer trajectory based on the sequence of identifications. The displays may receive the sequence of recommendations (per profile based on anonymous data, i.e., frequencies, features, and interactions) following the potential customer trajectory in the branch. The online recommender system may adapt the content to display according to the recommendation (a combination of circuit, profile, and product/service). Also, it may allow regulate the content according to the kind of objects (e.g., a toy is suitable for a child walking on the retail branch but not a wine bottle).

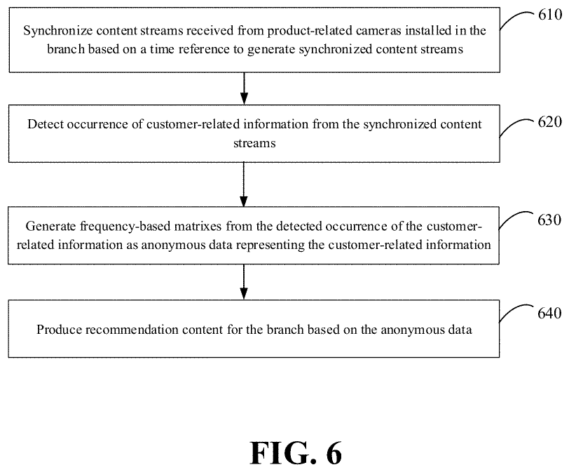

FIG. 6 illustrates an example flowchart of an autonomous recommendation procedure based on anonymous data according to some embodiments of the present disclosure. The autonomous recommendation procedure may be implemented by a processor circuitry in a BES for a branch and may include operations 610 to 620.

At operation 610, the processor circuitry may synchronize content streams received from product-related cameras installed in the branch based on a time reference to generate synchronized content streams.

According to some embodiments, the time reference may be generated by an internal clock of the BES for the branch synchronized to a NTP server.

At operation 620, the processor circuitry may detect occurrence of customer-related information from the synchronized content streams.

According to some embodiments, the customer-related information may include at least one of objects, interactions, events and entity profiles associated with one or more customers occurring in the content streams.

At operation 630, the processor circuitry may generate frequency-based matrixes from the detected occurrence of the customer-related information as anonymous data representing the customer-related information.

According to some embodiments, the anonymous data may be shareable to other branches in a same or different region as the branch.

At operation 640, the processor circuitry may produce recommendation content for the branch based on the anonymous data.

According to some embodiments, the recommendation content may include a sequence of advertisements fitting a customer profile or a sequence of recommendations of products or services associated with a customer trajectory.

According to some embodiments, the procedure may further include acquiring feedback content streams from feedback-related cameras installed in the branch; and detecting information about bought products from the feedback content streams. In the embodiments, the recommendation content may be produced based on the anonymous data and the information about the bought products.

It is noted that the BES may work for a corresponding branch independently without sharing the anonymous data representing the customer-related information with other BESs, and the BES may alternatively work as one or the branch edge servers in the data processing hierarchy as shown in FIG. 2 and share the anonymous data with other BESs in a same or different region.

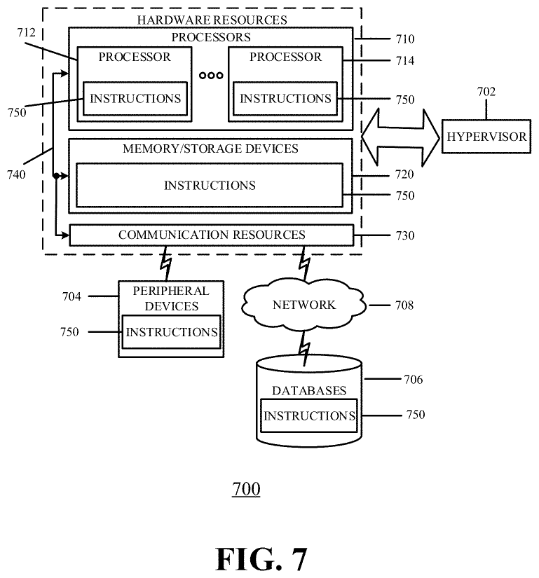

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

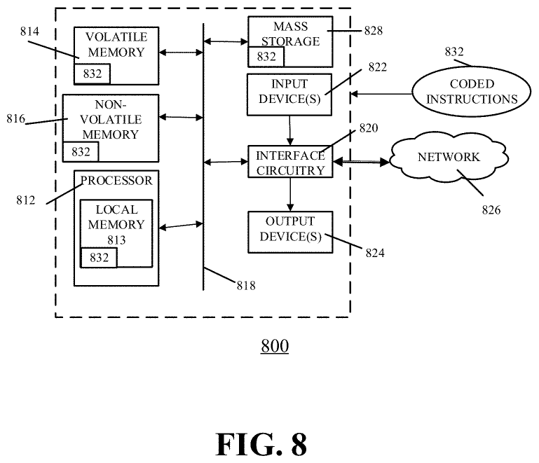

FIG. 8 is a block diagram of an example processor platform in accordance with some embodiments of the disclosure. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes interface circuitry 820. The interface circuitry 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuitry 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 820 of the illustrated example, thus, typically includes a graphics driver card, a graphics driver chip and/or a graphics driver processor.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 820 may include a training dataset inputted through the input device(s) 822 or retrieved from the network 826.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

Machine executable instructions 832 may be stored in the mass storage device 828, in the volatile memory 814, in the non-volatile memory 816, and/or on a removable non-transitory computer readable storage medium such as a CD or DVD.

Additional Notes and Examples:

Example 1 includes an autonomous recommendation system, comprising: one or more Branch Edge Servers (BESs), each BES being configured to generate anonymous data representing customer-related information based on content streams from product-related cameras installed in a branch corresponding to the BES, and provide recommendation content to the branch based on the anonymous data; one or more Edge Concentrator Servers (ECSs), each ECS being configured to aggregate the anonymous data from one or more BESs corresponding to respective branches in a region corresponding to the ECS to generate aggregated anonymous data shareable among regions corresponding to respective ECSs; and a Detection Orchestrator (DO) configured to coordinate operations of the BESs and the ECSs based on predefined policies.

Example 2 includes the autonomous recommendation system of Example 1, wherein the BES comprises: a content synchronizer configured to collect and synchronize the content streams to generate synchronized content streams based on a time reference; a customer-related information synthesizer configured to detect occurrence of the customer-related information from the synchronized content streams to generate the anonymous data; and an autonomous recommender configured to produce the recommendation content based on the anonymous data.

Example 3 includes the autonomous recommendation system of Example 2, wherein the time reference is generated by a time calibrator based on a master timing signal from the DO or the time reference is generated by an internal clock of the BES synchronized to a Network Time Protocol (NTP) server.

Example 4 includes the autonomous recommendation system of Example 2, wherein the customer-related information synthesizer comprises: a customer-related information detector configured to detect the occurrence of the customer-related information from the synchronized content streams, the customer-related information comprising at least one of objects, interactions, events and entity profiles associated with one or more customers occurring in the synchronized content streams; a real-time occurrence manager configured to generate frequency-based matrixes from the detected occurrence of the customer-related information as the anonymous data.

Example 5 includes the autonomous recommendation system of Example 4, wherein the customer-related information detector is trained based on predefined objects, interactions and events in the DO, and the real-time occurrence manager is configured to update the frequency-based matrixes to be aligned with the predefined objects, interactions, events and profiles in the DO.

Example 6 includes the autonomous recommendation system of Examples 2 to 5, wherein the autonomous recommender comprises: a real-time advertisement manager configured to produce a sequence of advertisements fitting a customer profile based on the anonymous data; a product and service recommender configured to produce a sequence of recommendations of products or services associated with a customer trajectory based on the anonymous data.

Example 7 includes the autonomous recommendation system of any of Examples 2 to 6, wherein the BES further comprises a feedback object detector configured to detect information about bought products from feedback content streams from feedback-related cameras installed in the branch and feedback the information about the bought products to the autonomous recommender.

Example 8 includes the autonomous recommendation system of Example 7, wherein the BES further comprises a feedback manager and an organizational memory; the feedback manager is configured to receive the information about the bought products and update the information about the bought products in the organization memory; and the organizational memory is configured to store the information about the bought products, and historical anonymous data and recommendation content.

Example 9 includes the autonomous recommendation system of any of Examples 2 to 8, wherein the BES further comprises: a layout manager configured to maintain a layout of the branch and positions of cameras and displays in the branch; and an object-interaction-event profiler configured to define one or more kinds of objects, interactions, and events to be detected.

Example 10 includes the autonomous recommendation system of Example 8, wherein the autonomous recommender is configured to produce the recommendation content based on the anonymous data, the information about the bought products, and the historical anonymous data and recommendation content.

Example 11 includes the autonomous recommendation system of any of Examples 1 to 10, wherein the anonymous data generated by each BES is shareable to other BESs for other branches.

Example 12 includes the autonomous recommendation system of any of Examples 1 to 11, wherein the DO comprises a temporal policy maker for providing temporal retention policies to the BESs and a concentrator policy maker for providing aggregation policies to the ECSs, and the predefined policies comprise at least one of the temporal retention policies and the aggregation policies.

Example 13 includes a Branch Edge Server (BES) for a branch, comprising: interface circuitry configured to receive content streams from product-related cameras installed in the branch; and processor circuitry coupled to the interface circuitry and configured to: synchronize the content streams based on a time reference to generate synchronized content streams; detect occurrence of customer-related information from the synchronized content streams; generate frequency-based matrixes from the detected occurrence of the customer-related information as anonymous data representing the customer-related information; and produce recommendation content for the branch based on the anonymous data.

Example 14 includes the BES of Example 13, wherein the time reference is generated by an internal clock of the BES synchronized to a Network Time Protocol (NTP) server.

Example 15 includes the BES of Example 13 or 14, wherein the customer-related information comprises at least one of objects, interactions, events and entity profiles associated with one or more customers occurring in the content streams.

Example 16 includes the BES of any of Examples 13 to 15, wherein the recommendation content comprises a sequence of advertisements fitting a customer profile or a sequence of recommendations of products or services associated with a customer trajectory.

Example 17 includes the BES of any of Examples 13 to 16, wherein the interface circuitry is further configured to receive feedback content streams from feedback-related cameras installed in the branch, and the processor circuitry is further configured to detect information about bought products from the feedback content streams and produce the recommendation content based on the anonymous data and the information about the bought products.

Example 18 includes the BES of any of Examples 13 to 17, wherein the anonymous data is shareable to other BESs for other branches.

Example 19 includes an autonomous recommendation method for a branch, comprising: synchronizing content streams received from product-related cameras installed in the branch based on a time reference to generate synchronized content streams; detecting occurrence of customer-related information from the synchronized content streams; generating frequency-based matrixes from the detected occurrence of the customer-related information as anonymous data representing the customer-related information; and producing recommendation content for the branch based on the anonymous data.

Example 20 includes the method of Example 19, wherein the time reference is generated by an internal clock of a Branch Edge Server (BES) for the branch synchronized to a Network Time Protocol (NTP) server.

Example 21 includes the method of Example 19 or 20, wherein the customer-related information comprises at least one of objects, interactions, events and entity profiles associated with one or more customers occurring in the content streams.

Example 22 includes the method of any of Examples 19 to 21, wherein the recommendation content comprises a sequence of advertisements fitting a customer profile or a sequence of recommendations of products or services associated with a customer trajectory.

Example 23 includes the method of any of Examples 19 to 22, further comprising: acquiring feedback content streams from feedback-related cameras installed in the branch; and detecting information about bought products from the feedback content streams, wherein producing the recommendation content comprises producing the recommendation content based on the anonymous data and the information about the bought products.

Example 24 includes a computer-readable medium having instructions stored thereon, wherein the instructions, when executed by processor circuitry, cause the processor circuitry to perform the method of any of Examples 19 to 23.

Example 25 includes an autonomous recommendation device, comprising means for performing the method of any of Examples 19 to 23.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium, wherein, when the program code is loaded into and executed by a machine, such as a computer, the machine becomes an apparatus for practicing the various techniques. The non-transitory computer readable storage medium may be a computer readable storage medium that does not include signal. In the case of program code execution on programmable computers, the computing system may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Exemplary systems or devices may include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system, comprising:
one or more Branch Edge Servers (BESs), each BES being configured to generate anonymous data representing customer-related information based on content streams from product-related cameras installed in a branch corresponding to the BES, and provide recommendation content to the branch based on the anonymous data;
one or more Edge Concentrator Servers (ECSs), each ECS being configured to aggregate the anonymous data from one or more BESs corresponding to respective branches in a region corresponding to the ECS to generate aggregated anonymous data shareable among regions corresponding to respective ECSs; and
a Detection Orchestrator (DO) configured to coordinate operations of the BESs and the ECSs based on predefined policies.

2. The system of claim 1, wherein the BES comprises:
a content synchronizer configured to collect and synchronize the content streams to generate synchronized content streams based on a time reference;
a customer-related information synthesizer configured to detect occurrence of the customer-related information from the synchronized content streams to generate the anonymous data; and
an autonomous recommender configured to produce the recommendation content based on the anonymous data.

3. The system of claim 2, wherein the time reference is generated by a time calibrator based on a master timing signal from the DO or the time reference is generated by an internal clock of the BES synchronized to a Network Time Protocol (NTP) server.

4. The system of claim 2, wherein the customer-related information synthesizer comprises:
a customer-related information detector configured to detect the occurrence of the customer-related information from the synchronized content streams, the customer-related information comprising at least one of objects, interactions, events and entity profiles associated with one or more customers occurring in the synchronized content streams;
a real-time occurrence manager configured to generate frequency-based matrixes from the detected occurrence of the customer-related information as the anonymous data.

5. The system of claim 4, wherein the customer-related information detector is trained based on predefined objects, interactions and events in the DO, and the real-time occurrence manager is configured to update the frequency-based matrixes to be aligned with the predefined objects, interactions, events and profiles in the DO.

6. The system of claim 2, wherein the autonomous recommender comprises:
a real-time advertisement manager configured to produce a sequence of advertisements fitting a customer profile based on the anonymous data;
a product and service recommender configured to produce a sequence of recommendations of products or services associated with a customer trajectory based on the anonymous data.

7. The system of claim 2, wherein the BES further comprises a feedback object detector configured to detect information about bought products from feedback content streams from feedback-related cameras installed in the branch and feedback the information about the bought products to the autonomous recommender.

8. The system of claim 7, wherein the BES further comprises a feedback manager and an organizational memory;
the feedback manager is configured to receive the information about the bought products and update the information about the bought products in the organization memory; and
the organizational memory is configured to store the information about the bought products, and historical anonymous data and recommendation content.

9. The system of claim 2, wherein the BES further comprises:
a layout manager configured to maintain a layout of the branch and positions of cameras and displays in the branch; and
an object-interaction-event profiler configured to define one or more kinds of objects, interactions, and events to be detected.

10. The system of claim 8, wherein the autonomous recommender is configured to produce the recommendation content based on the anonymous data, the information about the bought products, and the historical anonymous data and recommendation content.

11. The system of claim 1, wherein the anonymous data generated by each BES is shareable to other BESs for other branches.

12. The system of claim 1, wherein the DO comprises a temporal policy maker for providing temporal retention policies to the BESs and a concentrator policy maker for providing aggregation policies to the ECSs, and the predefined policies comprise at least one of the temporal retention policies and the aggregation policies.

13. An apparatus, comprising:
interface circuitry configured to receive content streams from product-related cameras installed in a branch; and
processor circuitry coupled to the interface circuitry and configured to:
synchronize the content streams based on a time reference to generate synchronized content streams;
detect occurrence of customer-related information from the synchronized content streams;
generate frequency-based matrixes from the detected occurrence of the customer-related information as anonymous data representing the customer-related information; and
produce recommendation content for the branch based on the anonymous data.

14. The apparatus of claim 13, wherein the customer-related information comprises at least one of objects, interactions, events and entity profiles associated with one or more customers occurring in the content streams.

15. The apparatus of claim 13, wherein the recommendation content comprises a sequence of advertisements fitting a customer profile or a sequence of recommendations of products or services associated with a customer trajectory.

16. The apparatus of claim 13, wherein
the interface circuitry is further configured to receive feedback content streams from feedback-related cameras installed in the branch, and
the processor circuitry is further configured to detect information about bought products from the feedback content streams and produce the recommendation content based on the anonymous data and the information about the bought products.

17. The apparatus of claim 13, wherein the anonymous data is shareable to other branches.

18. A method, comprising:
synchronizing content streams received from product-related cameras installed in a branch based on a time reference to generate synchronized content streams;
detecting occurrence of customer-related information from the synchronized content streams;
generating frequency-based matrixes from the detected occurrence of the customer-related information as anonymous data representing the customer-related information; and
producing recommendation content for the branch based on the anonymous data.

19. The method of claim 18, wherein the customer-related information comprises at least one of objects, interactions, events and entity profiles associated with one or more customers occurring in the content streams.

20. The method of claim 18, wherein the recommendation content comprises a sequence of advertisements fitting a customer profile or a sequence of recommendations of products or services associated with a customer trajectory.

21. The method of claim 18, further comprising:
acquiring feedback content streams from feedback-related cameras installed in the branch; and
detecting information about bought products from the feedback content streams,
wherein producing the recommendation content comprises producing the recommendation content based on the anonymous data and the information about the bought products.
